(19) United States
(12) Patent Application Publication
(10) Pub. No.: US 2019/0189163 A1
(43) Pub. Date: Jun. 20, 2019

(54) Image Processing Apparatus, Image Processing Method, Image Forming Apparatus, and Recording Medium

(71) Applicant: Kyocera Document Solutions Inc., Osaka (JP)

(72) Inventor: Kunihiko Tanaka, Osaka (JP)

(73) Assignee: Kyocera Document Solutions Inc.

(21) Appl. No.: 16/228,686

(22) Filed: Dec. 20, 2018

(30) Foreign Application Priority Data
Dec. 20, 2017 (JP) 2017-243611

(51) Int. Cl. G11B 27/34; G11B 27/19; G06F 3/0481; G06F 3/0484

(52) U.S. Cl. CPC G11B 27/34; G06F 3/04847; G06F 3/04817; G11B 27/19

(57) ABSTRACT

An image processing apparatus includes a still image data creation unit, an operation display, an operation display screen control unit, and a still image data extraction unit. The still image data creation unit creates a plurality of items of still image data from moving image data. The operation display screen control unit controls the operation display to cause the operation display to display an operation display screen. The operation display screen displays an interval setting bar for setting an extraction interval as an extraction target of the still image data from the moving image data. The still image data extraction unit calculates evaluation values of the still image data to extract the still image data from the plurality of items of still image data by using the evaluation values in the extraction interval set in the operation display screen.

### INCORPORATION BY REFERENCE

This application is based upon, wherein the benefit of priority is claimed from, corresponding Japanese Patent Application No. 2017-243611 filed in the Japanese Patent Office Dec. 20, 2017, and the entire contents of which are incorporated herein by reference.

### BACKGROUND

Unless otherwise indicated herein, the description in this section is not prior art to the claims in this application and is not admitted to be prior art by inclusion in this section.

In recent years, in association with performance improvement and image quality improvement of a video camera and a smartphone, still image data extractable from moving image data have been created. Considering such situation, there has been proposed a technique that supports extracting still image data desired by a user from moving image data. For example, there has been proposed a technique that grasps a change in a capture situation of moving image data from a variation characteristic of feature values included in a frame image of the moving image data and selects to display the frame image indicating the change. Meanwhile, there has been also proposed a technique that automatically prints a desired still image on another printing paper sheet by simply adding a selection mark on a list display of thumbnail images of a plurality of items of still image data printed on one printing paper sheet and causing a scanner to read the printing paper sheet with the added selection mark.

### SUMMARY

An image processing apparatus according to one aspect of the disclosure includes a still image data creation unit, an operation display, an operation display screen control unit, and a still image data extraction unit. The still image data creation unit creates a plurality of items of still image data from moving image data. The operation display screen control unit controls the operation display to cause the operation display to display an operation display screen. The operation display screen displays an interval setting bar for setting an extraction interval as an extraction target of the still image data from the moving image data. The still image data extraction unit calculates evaluation values of the still image data to extract the still image data from the plurality of items of still image data by using the evaluation values in the extraction interval set in the operation display screen.

An image forming apparatus of the disclosure includes the image processing apparatus and an image forming unit that forms an image on an image formation medium.

An image processing method of the disclosure includes: creating a plurality of items of still image data from moving image data; controlling the operation display to cause the operation display to display an operation display screen that displays an interval setting bar for setting an extraction interval as an extraction target of the still image data from the moving image data; and calculating evaluation values of the still image data to extract the still image data from the plurality of items of still image data by using the evaluation values in the extraction interval set in the operation display screen.

An image processing program of the disclosure causes an image processing apparatus to function as a still image data creation unit, an operation display screen control unit, and a still image data extraction unit. The still image data creation unit creates a plurality of items of still image data from moving image data. The operation display screen control unit controls the operation display to cause the operation display to display an operation display screen that displays an interval setting bar for setting an extraction interval as an extraction target of the still image data from the moving image data. The still image data extraction unit calculates evaluation values of the still image data to extract the still image data from the plurality of items of still image data by using the evaluation values in the extraction interval set in the operation display screen.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram illustrating a functional configuration of an image forming apparatus according to one embodiment of the disclosure.

FIG. 2 illustrates contents of a still image acquisition process according to the one embodiment.

FIGS. 3A and 3B illustrate operation display screens from selection to analysis start of a moving image according to the one embodiment.

FIGS. 4A and 4B illustrate operation display screens from analysis start to analysis completion of the moving image according to the one embodiment.

FIG. 5 illustrates a time series curve FC of a feature value according to the one embodiment.

FIGS. 6A and 6B illustrate operation display screens in an extraction interval adjustment process according to the one embodiment.

FIGS. 7A and 7B illustrate operation display screens in a still image selection process according to the one embodiment.

FIGS. 8A and 8B illustrate operation display screens in an extraction interval shift/addition process according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes a configuration for implementing the disclosure (hereinafter referred to as “embodiment”) with reference to the drawings.

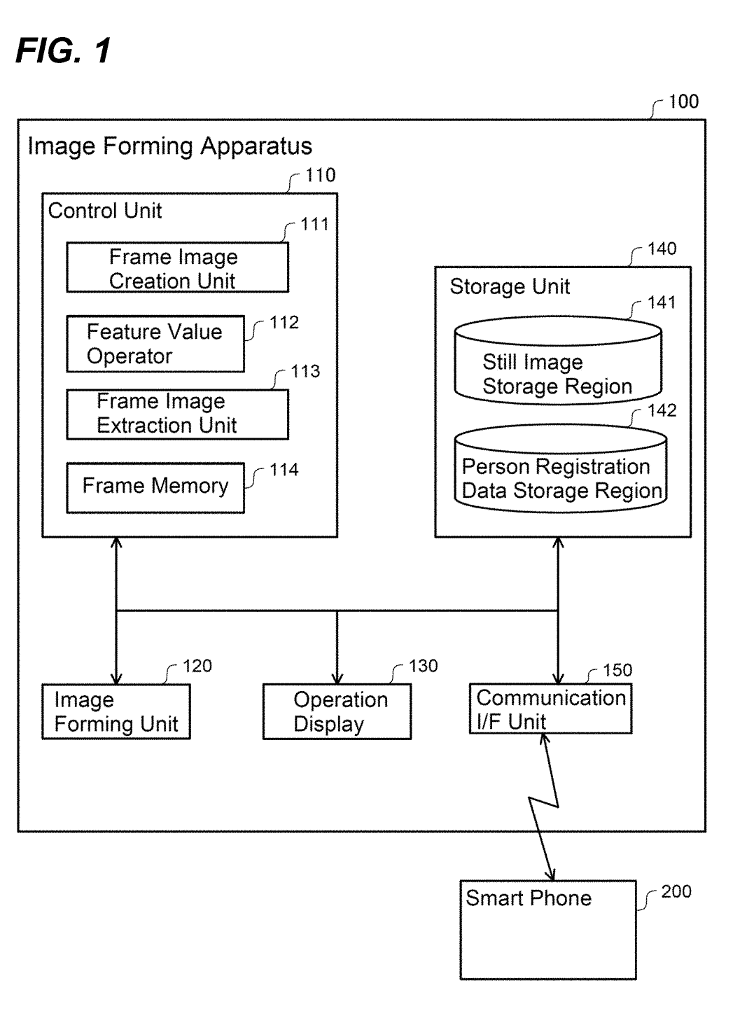

FIG. 1 illustrates a block diagram illustrating a functional configuration of an image forming apparatus 100 according to one embodiment of the disclosure. The image forming apparatus 100 includes a control unit 110, an image forming unit 120, an operation display 130, a storage unit 140, and a communication interface unit 150 (also referred to as a communication I/F unit). The operation display 130 functions as a touch panel and displays various menus as an input screen.

The image forming apparatus 100 is connected to a smartphone 200 by short range wireless communications via the communication interface unit 150. This enables the image forming apparatus 100 to receive moving image data imaged and created with the smartphone 200.

The embodiment uses Bluetooth® Class 2 for short-range wireless communications. Bluetooth® Class 2 short-range wireless communications perform communications at an output of 2.5 mW, and enable communication between the image forming apparatus 100 and the smartphone 200 at distances of up to about 10 m.

The control unit 110 includes a main storage unit, such as a RAM and a ROM, and a control unit, such as a micro-processing unit (MPU) and a central processing unit (CPU). The control unit 110 includes a controller function related to an interface such as various I/Os, a universal serial bus (USB), a bus, and other hardware. The control unit 110 controls the whole image forming apparatus 100.

The control unit 110 includes a frame image creation unit 111, a feature value operator 112, a frame image extraction unit 113, and a frame memory 114. The image forming unit 120 forms an image on a print medium. The frame image extraction unit 113 is also referred to as a still image data extraction unit. The print medium is also referred to as an image formation medium.

The storage unit 140 is a storage device including a non-transitory recording medium such as a hard disk drive and a flash memory and stores control programs and data for processes each executed by the control unit 110. The storage unit 140 further includes a still image storage region 141 to store frame image data and a person registration data storage region 142 in which face image data (also referred to as registered face image data) to detect a face of a person is registered. The person registration data storage region 142 also stores data expressing a threshold to extract the frame image data according to a general detection of a face.

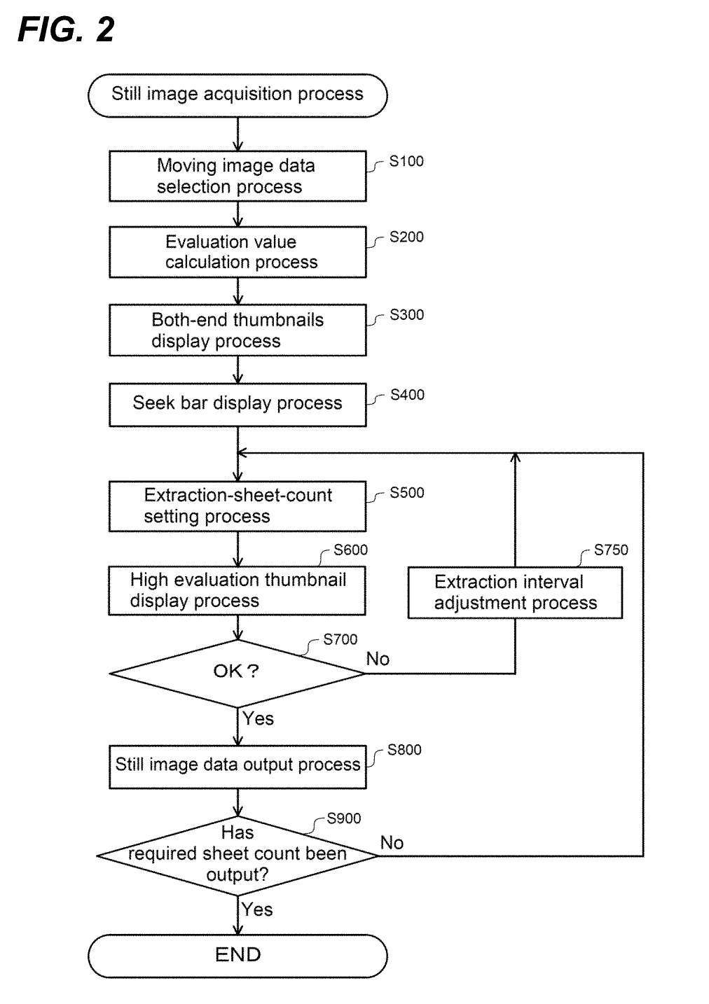

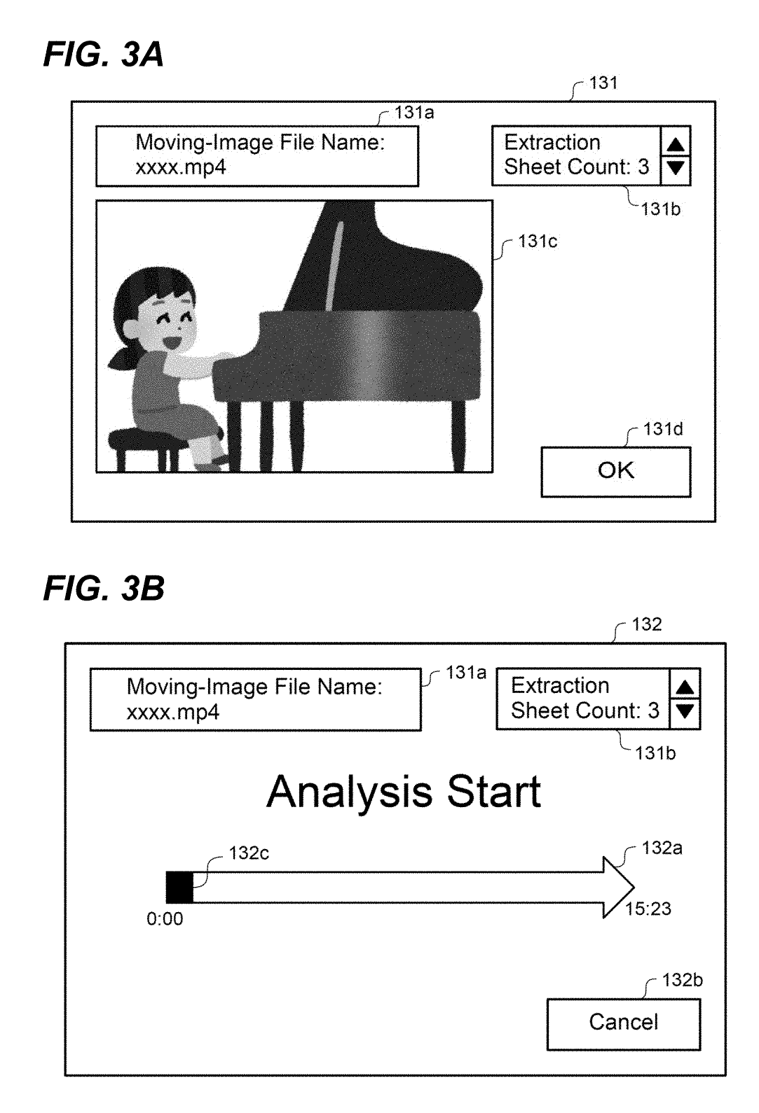

FIG. 2 illustrates contents of a still image acquisition process according to the one embodiment. FIGS. 3A and 3B illustrate operation display screens from selection to analysis start of a moving image according to the one embodiment. At Step S100, a user performs a moving image data selection process by using the operation display 130. In the moving image data selection process, the user selects one item of moving image data from a plurality of items of moving image data. The operation display 130 is controlled by the control unit 110 that functions as an operation display screen control unit.

In this example, the operation display 130 (see FIG. 3A) displays an operation display screen 131. The operation display screen 131 includes a moving image selection field 131a, an extraction sheet count setting field 131b, a thumbnail image display window 131c, and an OK button 131d. By using the moving image selection field 131a, the user can select the moving image data while viewing a thumbnail image displayed on the thumbnail image display window 131c.

In this example, the moving image selection field 131a indicates that the moving image data having a file name of xxxx.mp4 is selected. The thumbnail image display window 131c indicates the thumbnail image of the moving image data having the file name of xxxx.mp4. The user can select this moving image data by touching the OK button 131d.

At Step S200, the control unit 110 starts an evaluation value calculation process (also referred to as an analysis process) corresponding to the selection of the moving image data. The operation display 130 causes the screen to transition from the operation display screen 131 (see FIG. 3A) to an operation display screen 132 (see FIG. 3B) corresponding to the selection of the moving image data. The operation display screen 132 differs from the operation display screen 131 in that the operation display screen 132 displays a text string of “start analysis” and a progress bar 132a instead of the thumbnail image display window 131c while the OK button 131d is changed to a cancel button 132b. A terminating end of the progress bar 132a displays a playback end time (15 minutes 23 seconds) of the moving image data. The cancel button 132b is a button to abort the analysis process.

The analysis of the moving image data includes a frame image data creation process and a feature value calculation process of the frame image data. The frame image data creation process is a process that creates a plurality of items of frame image data from the moving image data and is executed by the frame image creation unit 111 of the control unit 110. The frame image creation unit 111 functions as a still image data creation unit. The feature value calculation process is executed by the feature value operator 112 of the control unit 110.

The frame image creation unit 111 further creates thumbnail image data from the reproduced frame image data. The frame image creation unit 111 associates each item of frame image data with the thumbnail image data and time data representing an extraction time of the frame image data and stores in the frame memory 114 of the control unit 110.

The feature value is set so as to quantitatively express that the still image is desired by the user. Accordingly, a local maximum value of the feature value is intended so as to express that the frame image is a frame image at the moment while an “image as intended” is captured when a photographer captures the photographed subject. In this example, the feature value is used as an evaluation value.

In this example, the “image as intended” means an image in which a face of a specific person can be captured large in a front view or an image in which a face of a person with a high level of smile is captured, based on the registered face image data registered in, for example, the person registration data storage region 142. The level of smile can be calculated by, for example, a statistical identification method that uses a well-known 3D model fitting method and uses shapes of eyes and a mouth and further images of peripheries of the eyes and the mouth.

The progress bar 132a includes a playback time (in this example, 15 minutes 23 seconds) of the moving image data and a status bar 132c indicating a progress status of the analysis process. The status bar 132c is configured to be longer in association with the progress of the analysis process.

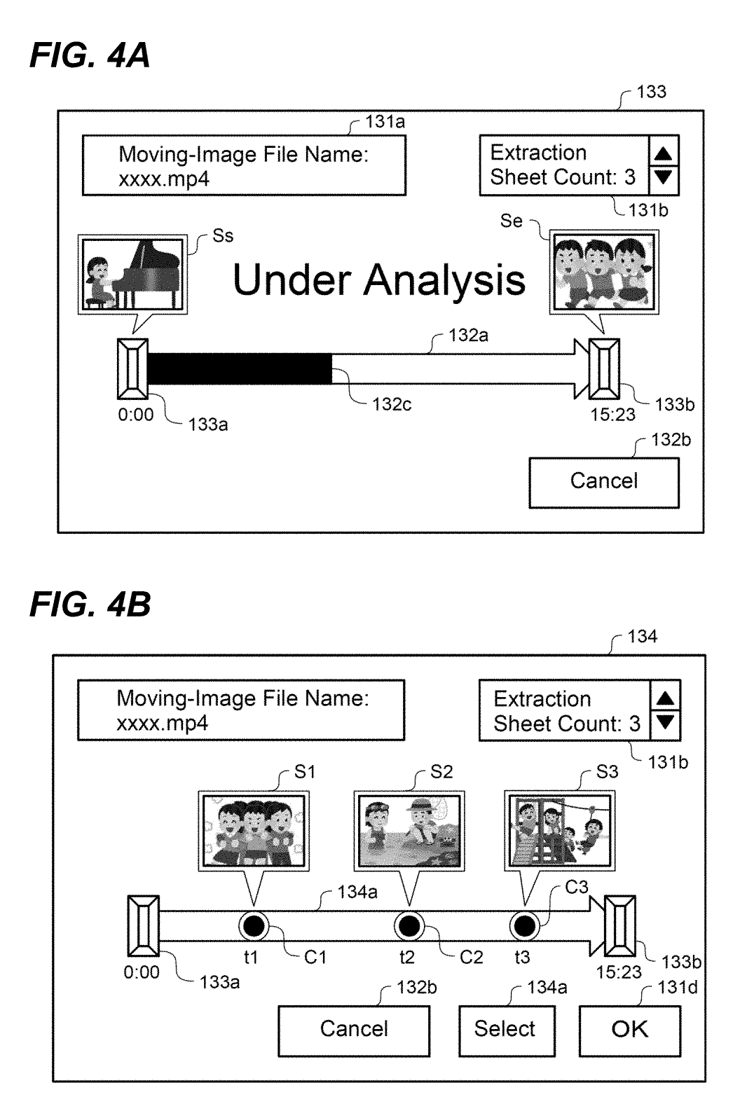

FIGS. 4A and 4B illustrate operation display screens from the analysis start to analysis completion of the moving image according to the one embodiment. FIG. 4A illustrates an operation display screen 133 during the analysis of the moving image data. In the operation display screen 133, a starting-end icon 133a and a terminating-end icon 133b are added at both ends of the progress bar 132a.

At Step S300, the control unit 110 executes a both-end thumbnails display process. In the both-end thumbnails display process, the control unit 110 displays a starting-end thumbnail image Ss and a terminating-end thumbnail image Se of the moving image data.

The starting-end thumbnail image Ss is added to the starting-end icon 133a. The starting-end thumbnail image Ss is created from a first key frame (also referred to as an I frame) of the moving image data. The terminating-end thumbnail image Se is added to the terminating-end icon 133b. The terminating-end thumbnail image Se is created from a last key frame of the moving image data.

The key frame is a frame encoded without use of inter-frame prediction. Since the key frame is a frame encoded without use of inter-frame prediction, it can be decoded alone before the analysis completion of the moving image data. The thumbnail image can be created by decreasing an image size of the decoded key frame

At step S400, the control unit 110 executes a seek bar display process. In the seek bar display process, the control unit 110 causes the operation display 130 to display an operation display screen 134 having a seek bar 134a instead of the progress bar 132a. The seek bar 134a differs from the progress bar 132a in that the seek bar 134a has time icons C1 to C3 of the three still images corresponding to an extraction sheet count instead of the status bar 132c. The seek bar 134a is also referred to as an interval setting bar.

At Step S500, the user can change the sheet count from three sheets as an initial setting by operating (inputting for setting) a spin button of the extraction sheet count setting field 131b. The setting of the extraction sheet count is possible at any time before, during, and after the analysis of the moving image data. In this example, assume that the user has not changed the extraction sheet count from the initial setting.

At Step S600, the frame image extraction unit 113 executes a high evaluation thumbnail display process. In the high evaluation thumbnail display process, the frame image extraction unit 113 adds thumbnail images S1 to S3 of three still images having large feature value, namely, high evaluation to the time icons C1 to C3 of the three still images, which correspond to the time when each still image has been extracted.

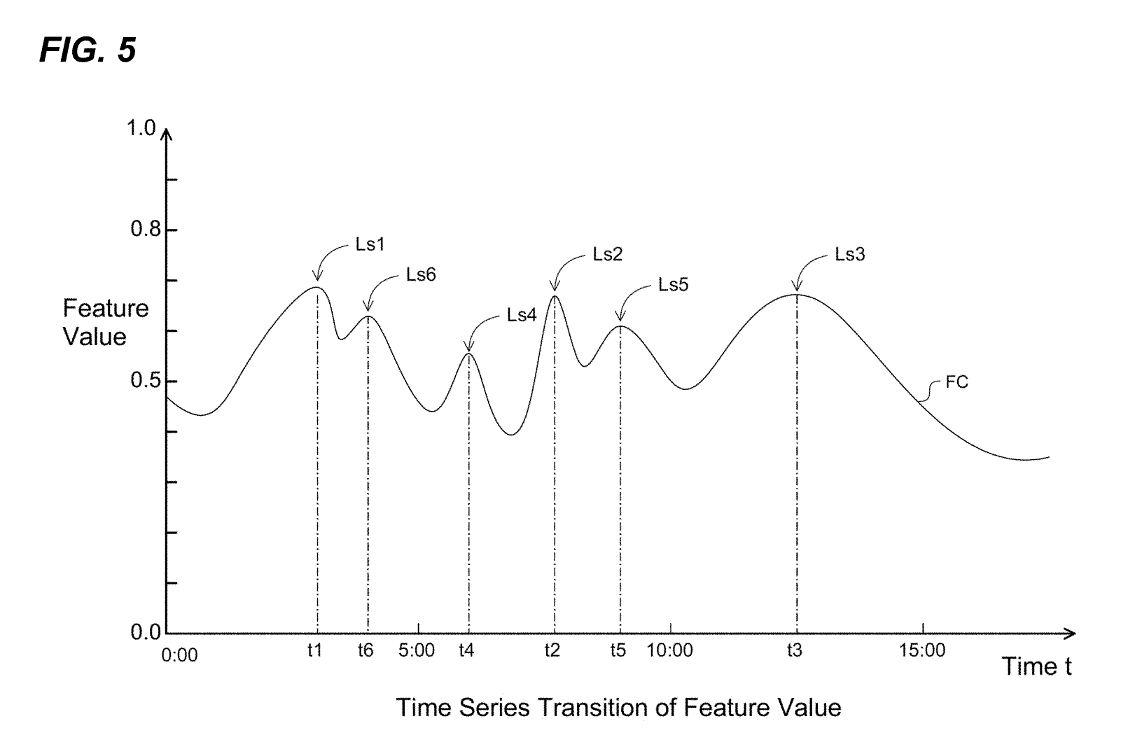

FIG. 5 illustrates a time series curve FC of the feature value according to the one embodiment. The horizontal axis indicates a playback time of the moving image data. The vertical axis indicates the feature value representing the evaluation of the still image. In this example, the thumbnail images S1 to S3 of the three still images indicate the first to the third (Ls1 to Ls3) still images among the local maximum values (total six items) of the feature value. The thumbnail images S1 to S3 are the thumbnail images of the still image data at times t1 to t3, respectively.

The frame image extraction unit 113, among the frame image data stored in the frame memory 114, sets a local maximum value flag with respect to each item of frame image data having the local maximum value of the feature value and sets a non-local maximum value flag with respect to each item of other frame image data. This stores each item of frame image data associated with the local maximum value flag (or non-local maximum value flag), the thumbnail image data, and the time data in the frame memory 114.

While the embodiment automatically extracts the still image data by using the local maximum value of the feature value, the local maximum value of the feature value does not always need to be used. For extraction of the still image data, it is only necessary to use the evaluation value that quantifies the evaluation of the still image.

At Step S700, the user determines whether the frame image data that the user desires to output as the still image data based on the thumbnail images S1 to S3 is present or not. When the frame image data that the user desires to output is present, the process proceeds to Step S800. When the frame image data that the user desires to output does not present, the process proceeds to Step S750.

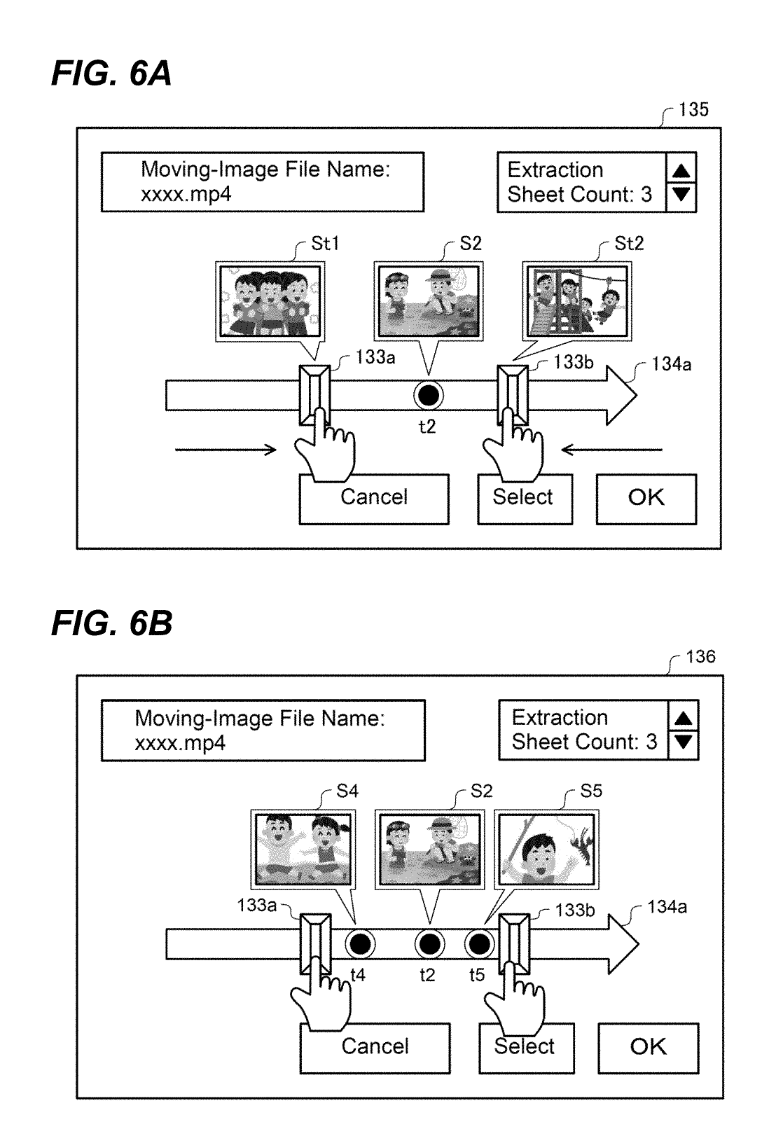

FIGS. 6A and 6B illustrate operation display screens in an extraction interval adjustment process according to the one embodiment. In this example, assume that the frame image data that the user desires to output does not present. The extraction interval adjustment process means a temporal interval that is a target to extract the still image data from the moving image data. Assume that the user searches another still image in a sequence of activities represented by the thumbnail image S2.

At Step S750, the user operates (slides) the starting-end icon 133a and the terminating-end icon 133b in an operation display screen 135 to bring them close to the time of the thumbnail image S2 (see FIG. 6A). The frame image extraction unit 113 determines a starting-end time of the extraction interval based on a position of the starting-end icon 133a and determines a terminating-end time of the extraction interval based on a position of the terminating-end icon 133b. An operation input of the operation is also referred to as a first operation input.

During movement of the starting-end icon 133a, a thumbnail image St1 of the key frame nearest to the time at which the starting-end icon 133a is present is displayed one after another. During movement of the terminating-end icon 133b, a thumbnail image St2 of the key frame nearest to the time at which the terminating-end icon 133b is present is displayed one after another. This enables the starting-end icon 133a and the terminating-end icon 133b to slide the still images at the starting end and the terminating end of the extraction interval while confirming at actual time.

Since this moves the thumbnail images S1 and S3 of the two still images away from the extraction interval, the frame image extraction unit 113 searches for new local maximum value of the feature value until reaching the extraction sheet count (three sheets). The frame image extraction unit 113 can instantly extract and display thumbnail images S4 and S5 by using the time data and the local maximum value flag stored in the frame memory 114. Consequently, the frame image extraction unit 113 can smoothly update the frame image data corresponding to the change of the extraction interval and display the thumbnail image without giving the user any operational stress.

An operation display screen 136 (see FIG. 6B) displays the two new thumbnail images S4 and S5 between the starting-end icon 133a and the terminating-end icon 133b, namely, at an adjacent time of the thumbnail image S2. The two thumbnail images S4 and S5 indicate the fourth and the fifth (Ls4 and Ls5) still images among the local maximum values (total six items) of the feature value, between the starting-end icon 133a and the terminating-end icon 133b (see FIG. 5). The two thumbnail images S4 and S5 are the thumbnail images of the still image data at times t4 and t5, respectively.

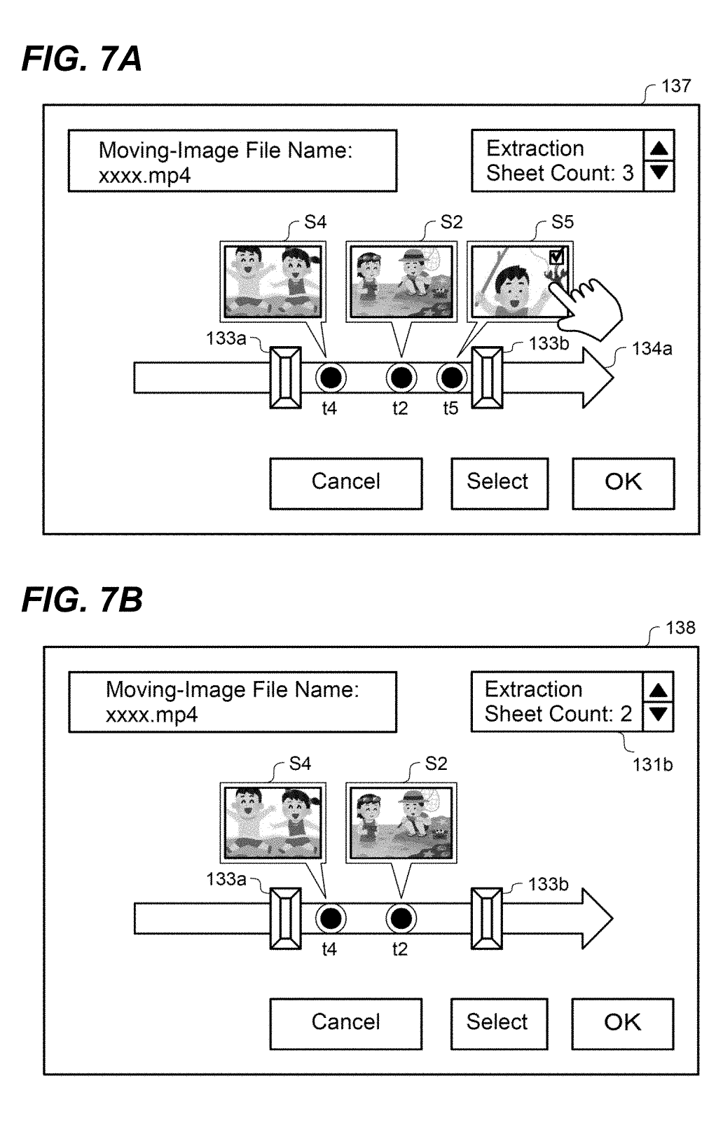

FIGS. 7A and 7B illustrate operation display screens in a still image selection process according to the one embodiment. In this example, assume that the user desires to output the still image data at the time t5 represented by the thumbnail image S5.

At Step S800, the user executes a still image data output process. In the still image data output process, the user can touch and select the thumbnail image S5. An operation display screen 137 (see FIG. 7A) displays the thumbnail image where a check mark is added to the thumbnail image S5 corresponding to the touch.

In an operation display screen 138 (see FIG. 7B), the frame image data represented by the thumbnail image S5 is output, the thumbnail image S5 is deleted, and the extraction sheet count is reduced by one sheet to be two sheets in the extraction sheet count setting field 131b. The output frame image data is stored in the still image storage region 141.

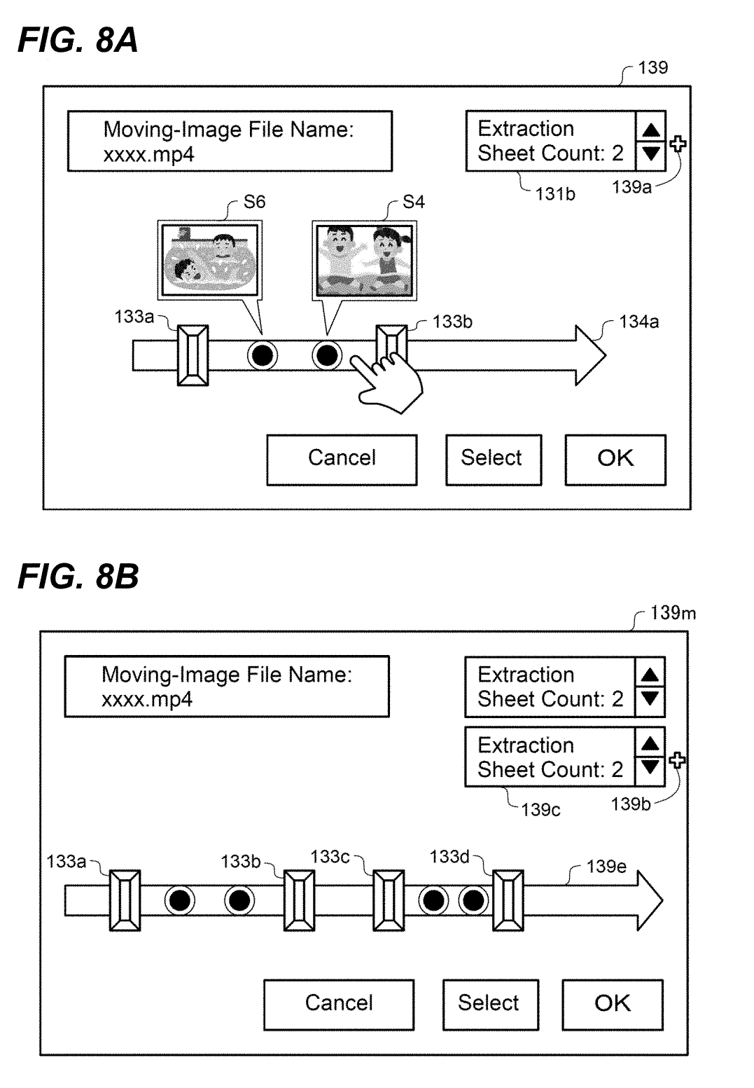

FIGS. 8A and 8B illustrate operation display screens in an extraction interval shift/addition process according to the one embodiment. An operation display screen 139 (see FIG. 8A) indicates a state where the extraction interval is shifted (moved) by touching and dragging the seek bar 134a between the starting-end icon 133a and the terminating-end icon 133b while maintaining the interval between the starting-end icon 133a and the terminating-end icon 133b. The operation input of the operation is also referred to as a second operation input.

In this example, the still image of the thumbnail image S2 is out of the extraction interval, and a still image of a thumbnail image S6 is newly extracted. The thumbnail image S6 indicates the sixth (Ls6) still image among the local maximum values (total six items) of the feature value between the starting-end icon 133a and the terminating-end icon 133b (see FIG. 5). The thumbnail image S6 is the thumbnail image of the still image data at a time t6.

The operation display screen 139 (see FIG. 8A) displays an addition icon 139a to execute the extraction interval addition process. By touching the addition icon 139a, the user can newly cause an operation display screen 139m (see FIG. 8B), where an extraction sheet count setting field 139c, a seek bar 139e, a starting-end icon 133c and a terminating-end icon 133d, and an addition icon 139b are added, to be displayed. Thus, a plurality of extraction intervals may be set. The operation input of the operation is also referred to as a third operation input.

Furthermore, in addition to the extraction sheet count, a count of persons photographed in the still image may be configured to be settable. In this case, only (or preferentially) the still image data where persons of the set count of persons are photographed is extracted.

At Step S900, the frame image extraction unit 113 determines whether all the still image data of the extraction sheet count (required sheet count) are output or not. When all the still image data of the extraction sheet count are output, namely, when the extraction sheet count becomes zero, the frame image extraction unit 113 displays a pop-up menu (not illustrated) indicating a fact that the process is to be terminated with respect to the user and then terminates the process. It is preferred that the pop-up menu display a setting screen (not illustrated) of the extraction sheet count in addition to an OK icon (not illustrated).

When all the still image data of the extraction sheet count have not been output yet, namely, when the extraction sheet count is not zero, the frame image extraction unit 113 returns the process to Step S500. This enable the user to resume an extraction operation of the still image data again.

Thus, the still image acquisition process according to the one embodiment ensures providing a user interface that facilitates setting the extraction interval as the extraction target of the still image data in extraction of the still image data from the moving image data.

### Modifications

In addition to the above-described respective embodiments, the disclosure can also be embodied by the following modification.

While in the above-described embodiments the disclosure is applied to the image forming apparatus, the disclosure is applicable to an apparatus that functions as an image processing apparatus such as a smartphone and a personal computer.

### Effects of Technology in Disclosure

Presently disclosed technology enables the facilitated setting of the extraction interval as the extraction target of the still image data in extraction of the still image data from the moving image data.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image processing apparatus comprising:
a still image data creation unit that creates a plurality of items of still image data from moving image data;
an operation display;
an operation display screen control unit that controls the operation display to cause the operation display to display an operation display screen, the operation display screen displaying an interval setting bar for setting an extraction interval as an extraction target of the still image data from the moving image data; and
a still image data extraction unit that calculates evaluation values of the still image data to extract the still image data from the plurality of items of still image data by using the evaluation values in the extraction interval set in the operation display screen.

2. The image processing apparatus according to claim 1, wherein:
the operation display screen control unit accepts a setting input to set an extraction sheet count of the still image data; and
the still image data extraction unit extracts the still image data by a sheet count set based on the setting input in the extraction interval.

3. The image processing apparatus according to claim 1, wherein:
the operation display screen control unit displays a starting-end icon for setting a starting end of the extraction interval and a terminating-end icon for setting a terminating end of the extraction interval and accepts a first operation input relative to the starting-end icon and the terminating-end icon; and
the still image data extraction unit updates the still image data corresponding to a change to the extraction interval set based on the first operation input.

4. The image processing apparatus according to claim 1, wherein:
the operation display screen control unit displays a starting-end icon for setting a starting end of the extraction interval and a terminating-end icon for setting the terminating end of the extraction interval, accepts a second operation input relative to the interval setting bar between the starting-end icon and the terminating-end icon, and shifts the starting-end icon and the terminating-end icon corresponding to the second operation input while maintaining an interval between the starting-end icon and the terminating-end icon; and
the still image data extraction unit updates the still image data corresponding to a change to the extraction interval set based on the second operation input.

5. The image processing apparatus according to claim 1, wherein:
the operation display screen control unit displays an addition icon for adding the extraction interval and accepts a third operation input relative to the addition icon; and
the still image data extraction unit newly adds the extraction interval based on the third operation input.

6. An image forming apparatus comprising:
the image processing apparatus according to claim 1; and
an image forming unit that forms an image on an image formation medium.

7. An image processing method comprising:
creating a plurality of items of still image data from moving image data;
controlling an operation display to cause the operation display to display an operation display screen, the operation display screen displaying an interval setting bar for setting an extraction interval as an extraction target of the still image data from the moving image data; and
calculating evaluation values of the still image data to extract the still image data from the plurality of items of still image data by using the evaluation values in the extraction interval set in the operation display screen.

8. A non-transitory computer-readable recording medium storing an image processing program to control an image processing apparatus, the image processing program causing the image processing apparatus to function as:
a still image data creation unit that creates a plurality of items of still image data from moving image data;
an operation display screen control unit that controls an operation display to cause the operation display to display an operation display screen, the operation display screen displaying an interval setting bar for setting an extraction interval as an extraction target of the still image data from the moving image data; and
a still image data extraction unit that calculates evaluation values of the still image data to extract the still image data from the plurality of items of still image data by using the evaluation values in the extraction interval set in the operation display screen.
